(19) United States
(12) Patent Application Publication
(10) Pub. No.: US 2015/0033871 A1
(43) Pub. Date: Feb. 5, 2015

(54) Monitoring System and Sight Port for Liquid-Gas Transport Line

(71) Applicant: Strom W. Smith, Gulfport, MS (US)

(72) Inventor: Strom W. Smith, Gulfport, MS (US)

(21) Appl. No.: 14/447,820

(22) Filed: Jul. 31, 2014

Related U.S. Application Data
(60) Provisional application No. 61/861,219, filed on Aug. 1, 2013.

(51) Int. Cl. G01F 1/74

(52) U.S. Cl. CPC G01F 1/74
USPC 73/861.04

(57) ABSTRACT

A monitoring system for use in a liquid-gas mixture transport line includes a chamber containing a phase separator, a liquid flow measurement device downstream of the phase separator, a collector trap intermediate the phase separator and the flow measurement device, and an overflow opening downstream of the flow measurement device. A sight port is provided in the chamber. A chamber inlet is elevated in relation to the collector trap, the flow measurement device and a chamber outlet. In an embodiment of the invention, the chamber is double-walled with the sight port having a lens in each wall and a filler media, such as inert gas, between the lenses. In one embodiment, the filler media is heated to control formation of condensation or solid sulfur on the lens interior of the chamber. In other embodiments, a sight port of the present invention is provided in a liquid flow transport line.

### CROSS-REFERENCE TO RELATED APPLICATIONS

This application claims the benefit of U.S. Provisional Application No. 61/861,219 filed on Aug. 1, 2013, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

1. Field of the Invention

The present invention relates to the transportation and monitoring of liquid-gas mixtures. More particularly, the present invention provides a mechanism for visual monitoring, and flow rate measurement of liquid, such as a mixture of molten sulfur and gas-phase products, in a two-phase mixture flowing through a piping system, and a sight port for viewing said monitoring system.

2. Description of the Related Art

Sulfur is used for manufacturing sulfuric acid, medicine, cosmetics, fertilizers, and rubber products. The majority of sulfur produced worldwide is byproduct sulfur from crude oil refineries and other hydrocarbon processing plants. Hydrogen sulfide produced by such plants is typically converted to sulfur using the Claus process. The resulting sulfur and gases are commonly transported in a liquid-gas two-phase state via pipelines, with the sulfur being kept heated so as to remain in a liquid phase. Sulfur has a melting point of approximately 115° C. (240° F.) and will begin to solidify at temperatures below this point. Therefore, liquid sulfur is typically transported at elevated temperatures in a molten state at approximately 135° C. to 140° C. (275° F. to 284° F.) to provide for optimum viscosity.

The elevated temperature and two-phase state of the mixture make determining the flow rate of the molten sulfur difficult. Traditionally, flow rate has been monitored using a sight port or viewing box to visually observe flow of the mixture. Benefits of visual inspection include allowing the operator to visually observe the viscosity of the mixture or observe the flow for foreign objects. The elevated temperature of the mixture flowing within the pipe often causes the sight port to fog or gather condensation, obstructing the view of the operator.

Several types of fluid flow meters are known that may provide flow rates. However, when both liquid and gases are present, such as in sulfur recovery and transport operations, standard flow measurement methods are of limited accuracy in measuring flow of the liquid because varying quantities of gases in the mixture affects accuracy.

### BRIEF SUMMARY OF THE INVENTION

A monitoring system for use in a liquid-gas mixture transport line includes a chamber containing a phase separator, a liquid flow measurement device downstream of the phase separator, a collector trap intermediate the phase separator and the flow measurement device, and an overflow opening downstream of the flow measurement device. A chamber inlet is elevated in relation to the collector trap, the flow measurement device, and a chamber outlet. A sight port and a viewing/access box are provided in the chamber.

In an embodiment of the invention, the chamber is double-walled with a sight port having a lens in each wall and a filler media, such as inert gas, between the lenses. In an embodiment of the invention, the filler media is heated to control formation of condensation or solid sulfur on the lens interior of the chamber.

Other features and advantages of the invention will be apparent from the following description, the accompanying drawings, and the appended claims.

### BRIEF DESCRIPTION OF THE DRAWINGS

FIG. 1 is a longitudinal cross-sectional view of a monitoring system.

FIG. 2 is a perspective view of the monitoring system and sight port.

FIG. 3 is a transverse cross-sectional view of the monitoring system and sight port.

FIG. 4 is a transverse cross-sectional view of the sight port.

### DETAILED DESCRIPTION OF THE INVENTION

Referring now to the drawings wherein like reference characters designate like or similar parts throughout.

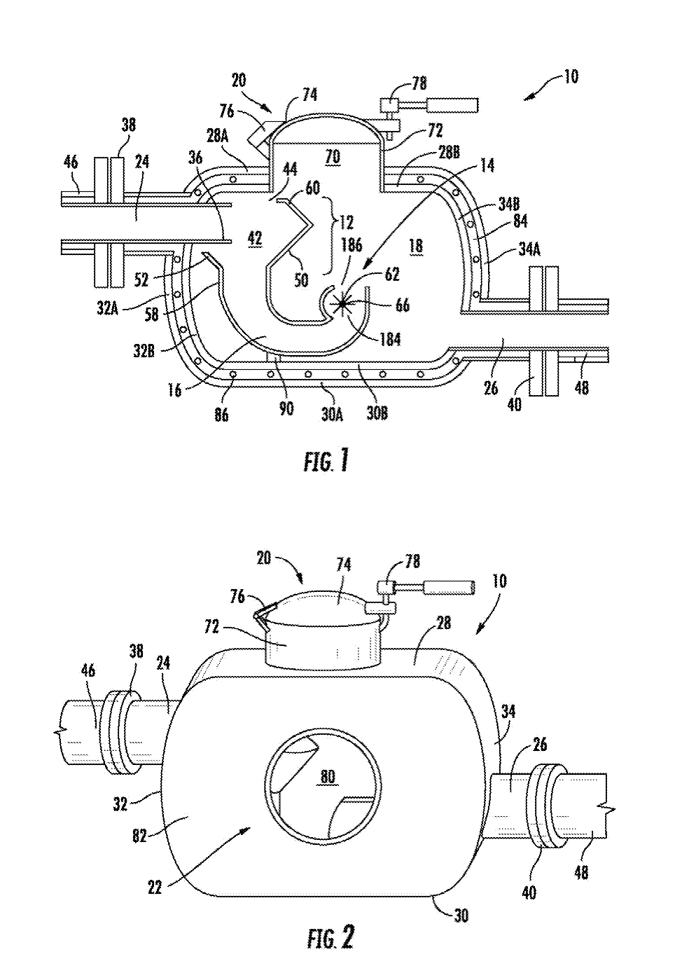

FIG. 1 depicts a cross-sectional, longitudinal view of a monitoring system 10 for use in a liquid-gas mixture transport line. Monitoring system 10 includes a phase separator 12, a liquid flow measurement device 14, and a collector trap 16. The phase separator 12, flow measurement device 14, and collector trap 16 are contained within a chamber 18. A viewing/access box 20 is provided at chamber top wall 28 (FIG. 2). A chamber inlet 24 and a chamber outlet 26 are provided. Referring to FIG. 2, a sight port 22 is provided in side wall 82 of chamber 18.

Referring to FIGS. 1, 2, and 3, chamber 18 comprises a sealable compartment defined generally by chamber top wall 28, chamber bottom wall 30, chamber inlet end wall 32, and chamber outlet end wall 34.

Chamber inlet 24 extends through the upper portion of chamber inlet end wall 32 proximate chamber top wall 28. Chamber outlet 26 extends through the lower portion of chamber outlet end wall 34 proximate chamber bottom wall 30. Accordingly, chamber inlet 24 is positioned at an elevated position in relation to chamber outlet 26. Such positioning allows gravity flow of liquids (not shown) from chamber inlet 24 to chamber outlet 26.

Chamber inlet 24 comprises a pipe segment having an inlet extension 36 extending inwardly of chamber 18 and a distal inlet flange 38 for connection to upstream pipe 46 for transporting liquids and gases. Chamber outlet 26 comprises an outlet flange 40 for connection to downstream pipe 48 for transporting liquids and gases. In additional embodiments, other connection means, such as screwed connections, may be utilized.

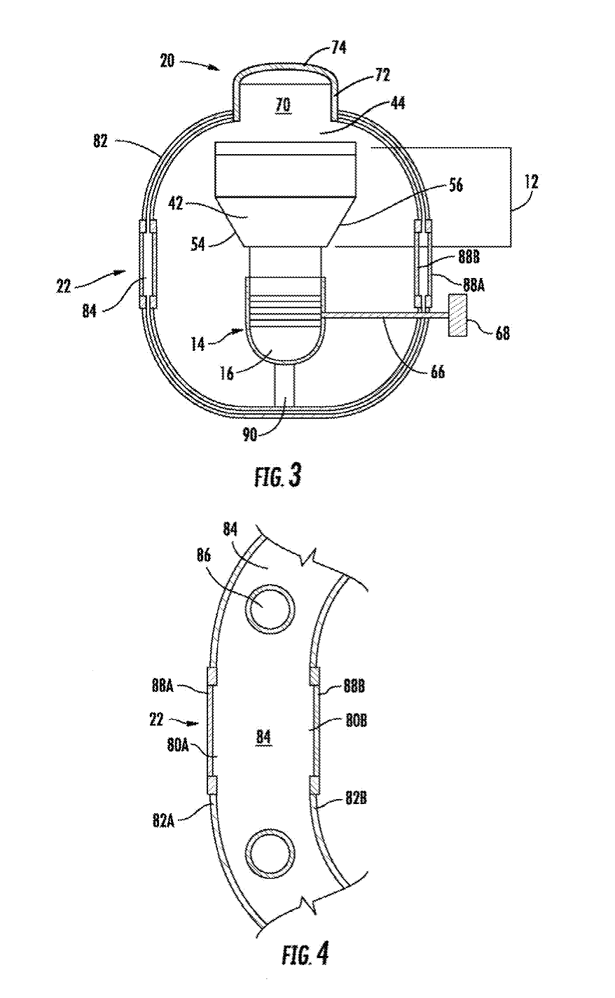

Referring to FIGS. 1 and 3, gas-liquid phase separator 12 comprises a funnel 42 positioned at least partially below inlet extension 36 and an upper vent 44 positioned at least partially above inlet extension 36. Funnel 42 is defined by front funnel wall 50, rear funnel wall 52, and side funnel walls 54, 56. Front funnel wall 50, rear funnel wall 52, and side funnel walls 54, 56 extend upwardly and outwardly from trap connector tube 58. Accordingly, liquid flowing from inlet extension 36 is directed by funnel 42 to trap connector tube 58.

A splash guard 60 is provided on funnel 42 extending upwardly from at least front funnel wall 50. Splash guard 60 may further extend upward from side walls 54 and 56, and portions of rear funnel wall 52, to prevent splashing of liquid outside funnel 42.

Funnel 42 may be constructed as a multiple wall structure, as described above, or may have a curvilinear wall structure.

Separator 12 is separated from inlet extension 36 to allow for flow of gases (not shown) out of inlet extension 36 into chamber 18. Chamber 18 has an interior cross-sectional area that is larger than the cross-sectional area of inlet extension 36.

Collector trap 16 is removeably attached to inner chamber bottom wall 30B (as depicted in FIG. 1) and/or inner chamber side wall 82B by one or more mounting brackets 90. Mounting brackets 90 support collector trap 16, separator 12, and flow measurement device 14 in an upright orientation.

Phase separator 12 is positioned such that funnel 42 is positioned at least partly below inlet extension 36 to allow liquid flow from inlet extension 36 into funnel 42.

Connector tube 58 extends from funnel 42 to collector trap 16. Collector trap 16 comprises a generally U-shaped pipe segment. A flow measurement device 14 is positioned at the end of collector trap 16 distal connector tube 58. Flow measurement device 14 may be a commercially-available flow meter of the type to measure liquid flow through a tube or pipe, including for example, a paddle wheel meter or a turbine meter. For illustration purposes, flow measurement device 14 is depicted as comprising a paddle wheel 62 in a measurement device chamber 184, connected by axle 66 to a counter 68. Counter 68 may include a processor (not shown) or be connected to an external processor (not shown) for quantifying, recording, and/or providing output of liquid flow measurement data from flow measurement device 14. As would be known to those skilled in the art, other useful means of providing information from flow measurement device 14 external to chamber 18 may be utilized.

A measurement device outlet 186 allows flow of liquid (not shown) from flow measurement device 14 outwardly into chamber 18, and thence out chamber outlet 26.

Still referring to FIGS. 1, 2 and 3, a viewing box 20 is provided at chamber top wall 28. A viewing box opening 70 is provided in chamber top wall 28. Viewing box side walls 72 extend through viewing box opening 70 upward from chamber 18. A viewing box cap 74 is mounted on viewing box side walls 72. The viewing box cap 74 is attached by a viewing box hinge 76 to a viewing box side wall 72. The viewing box cap 74 is further releasably attached to viewing box side wall distal hinge 76 by a viewing box latch 78. The viewing box side walls 72, viewing box cap 74, viewing box hinge 76, and viewing box latch 78 are constructed to allow sealing engagement of viewing box cap 74 to viewing box side walls 72 and to allow opening of viewing box cap 74 to access the interior of chamber 18. In other embodiments, access to chamber 18 may be provided by any suitable means which provides for sealability of chamber 18 during operation.

Viewing box side walls 72 may be constructed as a multiple wall structure or may have a curvilinear wall structure.

Referring now to FIGS. 2 and 3, a sight port opening 80 is provided in chamber side walls 82A, 82B to allow installation of a sight port 22. Sight port opening 80 and sight port 22 are constructed and positioned to allow monitoring of flow within the interior of chamber 18 through sight port 22.

In an exemplary embodiment, chamber top wall 28, chamber bottom wall 30, inlet end wall 32, outlet end wall 34, and chamber side walls 82 each are constructed as double walls with an inner wall and an outer wall defining a wall space between the respective inner wall and outer wall. Referring to FIG. 1, outlet end wall 34 comprises an outer wall 34A and an inner wall 34B defining an interior wall space 84. In like manner, chamber bottom wall 30 comprises an outer wall 30A and an inner wall 30B further defining interior wall space 84. Chamber inlet end wall 32, top wall 28, and side walls 82 are likewise constructed of an inner wall 32B, 28B, and 82B, and an outer wall 32A, 28A, and 82A, respectively, with space 84 there between.

Steam coils 86 are positioned in space 84 at intervals. Steam coils 86 are connected to a steam supply source (not shown) and a steam supply outlet (not shown) and a steam control (not shown). Accordingly, steam (not shown) may be circulated within steam coils 86 in space 84 to heat space 84, lenses 88A, 88B (FIG. 4), and chamber 18 as needed.

Referring to FIG. 4, an exemplary embodiment of sight port 22 is depicted. A sight port opening 80A is provided in chamber outer side wall 82A. A corresponding sight port opening 80B is provided in inner side wall 82B. Openings 80A and 80B are of substantially equivalent size and alignment. A sight port lens 88A is fixedly attached to and sealingly engaged with chamber outer side wall 82A at opening 80A. A corresponding sight port lens 88B is fixedly attached to and sealingly engaged with inner side wall 82B at inner opening 80B. Sight port lenses compatible with the present invention allow visual observation there through and may comprise materials such as, but not limited to, glass, tempered glass, quartz, plastic, and combinations thereof. Sight port lens 88A and sight port lens 88B are substantially parallel to one another when positioned in their respective sight port openings 80A, 80B in chamber side walls 82A, 82B. In an embodiment of the present invention depicted by FIG. 3, both “front” outer side wall 82 (as observable in the orientation depicted in FIG. 2) and “back” outer side wall 82 (not observable in FIG. 2) each comprise a sight port opening 80 to allow installation of a sight port 22 as described herein.

In a further embodiment of the present invention (not shown), the double-walled construction and sight port arrangement may be employed for use with a liquid-gas transport line, but not in conjunction with a flow measurement device. In one such embodiment, a chamber of the present invention containing a liquid-gas phase separator, but not including a flow measurement device, may be utilized to separate the liquid and provide liquid flow observation. Such liquid flow observation may, however, include a paddle wheel, or other flow movement indicator, that while not quantifying liquid flow, provides a visual means of ascertaining whether or not there is flow through the system.

In another embodiment (not shown), a liquid transport line (pipe) itself may be modified to incorporate the sight port system of the present invention. In one aspect, a liquid-gas flow separation system, such as one described in U.S. Pat. No. 5,498,270 to Smith (or prior art separation systems disclosed therein), or U.S. Pat. No. 7,112,308 to Smith, may be utilized to provide a substantially degassed liquid flow, and such liquid flow may be introduced to a sight port system of the present invention to provide flow observation and, if desired, flow measurement. In one such embodiment, the pipe modification comprises a chamber, with a sight port of the present invention, provided between two sections of pipe. In one aspect, double-walled chamber construction employing a sight port lens sealingly disposed within an inner wall and another sight port lens sealingly disposed within an outer wall may be utilized. Consistent with the present invention, providing heat proximate the lenses, including the space between the lenses and the space between the inner and outer walls, to prevent or minimize condensation or solidification, may improve liquid flow observation.

In any of the various exemplary embodiments, space 84 may be filled with a gas filler (not shown), such as an inert gas, to limit condensation in space 84. To accomplish this, appropriate seals (not shown) and valves (not shown) may be provided to limit escape of the filler gas.

One or more steam coils 86 are disposed in space 84 proximate sight port 22 but spaced from sight port 22 to allow unobstructed viewing from exterior of chamber 18 through sight port lens 88A and sight port lens 88B to the interior of chamber 18.

Steam coils 86 are operable to provide elevated temperature of any gas within space 84 and at lenses 88A and 88B to maintain an elevated temperature of lenses 88A and 88B. Accordingly, steam coils 86 are operable to heat lenses 88A and 88B to a temperature to limit gas condensation and/or solidification of liquids, such as sulfur, on lenses 88A and 88B.

In an alternative embodiment, heated fluids other than steam may be used in coils 86. In an alternative embodiment, other heating means, such as electrical heating elements, may be utilized to heat lenses 88A and 88B to limit condensation/solidification on the lenses 88A and 88B. In an alternative embodiment, radiant heat may be directed toward lenses 88A and 88B to increase lens temperature and to limit condensation/solidification on lenses 88A and 88B. In an alternative embodiment, electrical heating elements (not shown) may be embodied within each of lenses 88A and 88B to heat lenses 88A and 88B to limit condensation/solidification on lenses 88A and 88B.

### Operation of Liquid-Gas Flow Measurement Device

Referring again to FIG. 2, liquid-gas mixture (not shown) in the upstream pipe 46 enters the monitoring system 10 chamber 18 through chamber inlet 24. A liquid-gas mixture (not shown) flows through inlet extension 36 to the phase separator 12, whereby gravity causes liquids (not shown) to flow downward through funnel 42 and trap connector tube 58 into collector trap 16. Splash guard 60 prevents liquids (not shown) from bypassing flow measurement device 14. Simultaneously, gases (not shown) in the liquid-gas mixture are released through upper vent 44 directly into chamber 18 and thereby bypass flow measurement device 14. The cross-sectional area of chamber inlet extension 36 is smaller than the cross-sectional area of chamber 18. This is necessary because the phase separator 12 requires the use of gravity to separate the liquid (not shown) from the gas (not shown); therefore, there must be a sufficient chamber 18 height to allow gravity to have an effect on the mixture to draw liquid downward from the chamber inlet extension 36 into the funnel 42.

As liquid (not shown) continues to flow into collector trap 16, the liquid level will rise, causing liquid to flow into measurement device chamber 184, through flow measurement device 14, and exit through measurement device outlet 186. This ensures an accurate flow measurement device 14 output reading, as all liquids (not shown) are directed through the flow measurement device 14, while all gases (not shown) are released through upper vent 44, so as to not interfere with the flow measurement device 14. The shape of the collector trap 16 and the positioning of the flow measurement device 14 below chamber inlet 24 ensure that gases entering through chamber inlet 24 do not affect the flow measurement device 14. In the depicted embodiment, flow measurement device 14 is a paddle wheel 62. The flow of liquid through measurement device chamber 184 causes paddle wheel 62 to rotate. A counter 68 collects data and either processes the data or transmits the data to an external processor for quantifying and recording of the data.

Liquids (not shown) flowing through measurement device outlet 186 are recombined with gases (not shown) in chamber 18. The newly recombined liquid-gas mixture then exits the monitoring system 10 through chamber outlet 26. Chamber outlet 26 is located proximate chamber bottom wall 30 to allow gravity to force the recombined liquid-gas mixture out of the chamber 18 through chamber outlet 26.

During operation, viewing box 20 allows samples to be taken. Viewing box 20 allows cleaning of the internal components of the monitoring system 10 when not in operation. Operators may release viewing box latch 78 and rotate viewing box cap 74 about hinge 76 to expose viewing box opening 70, through which the internal components of the monitoring system 10 may be accessed.

During operation, visual inspection of the flow of the liquid-gas mixture (not shown) is accomplished by sight port 22. Steam coils 86 within space 84 are heated by circulating steam (not shown) within the steam coils 86 to heat space 84 as necessary. Interior wall space 84 may be filled with an inert gas or other suitable material. The elevated temperature of space 84 will cause elevation in the temperature of sight port lenses 88A and 88B. This will prevent condensation or solidified sulfur from forming on sight port lenses 88A, 88B.

### Method

An exemplary method of utilizing the monitoring system 10 to monitor a liquid-gas mixture and compile liquid flow rate data may include a providing step, an installation step, an introducing step, a mixture separating step, a flow rate data collecting step, a data processing and output step, a recombining step, an exiting step, and a cleaning step.

An exemplary method may include a providing step. A monitoring system 10 including at least a phase separator 12, collector trap 16, and flow measurement device 14 are provided. The monitoring system may include other features as described herein.

An exemplary method may include an installation step, wherein monitoring system 10 is installed into a two-phase mixture piping system. Upstream pipe 46 is sealingly connected to inlet flange 38 of chamber inlet 24. Downstream pipe 48 is sealingly connected to outlet flange 40 of chamber outlet 26.

An exemplary method includes an introducing step. A liquid-gas mixture (not shown) is introduced into piping system such that the mixture flows from upstream pipe 46 through chamber inlet 24 and into monitoring system 10 chamber 18.

An exemplary method includes a mixture separating step. As liquid-gas mixture enters monitoring system 10 through chamber inlet 24, gravity causes liquid to flow down funnel 42 into collector trap 16, while the natural movement of the gases will cause them to flow through upper vent 44 and into chamber 18.

An exemplary method includes a flow rate data collection step. As liquid gathers in the collector trap 16, liquid will be forced to flow into measurement device chamber 184. The liquid will then flow through flow measurement device 14 and measurement device outlet 186 into chamber 18. Counter 68 simultaneously collects data while flow measurement device 14 is in operation. In the depicted embodiment, flow measurement device 14 is a paddle wheel 62, which connects to counter 68 by an axle 66. The force of flowing liquid rotates paddle wheel 62 and axle 66 as it flows through measurement device chamber 184. Rotation of the axle 66 transmits data to counter 68.

An exemplary method may include a data processing step. Flow measurement device 14 data collected by counter 68 may be processed as necessary by an internal processor (not shown) or may be transmitted to an external processor (not shown) to quantify, record, and output flow rate measurement data.

An exemplary method may include a recombining step. After flowing through measurement device chamber 184 and flow measurement device 14, liquid flows through measurement device outlet 186 and into chamber 18. In chamber 18, liquid may be at least partly recombined with the gases that bypassed collector trap 16 and flow measurement device 14 through upper vent 44.

An exemplary process may contain an exit step, whereby the recombined liquid-gas mixture exits chamber 18 by flowing through chamber outlet 26 into downstream pipe 48. This movement will happen naturally as a result of gravity due to the placement of chamber outlet 26 proximate chamber bottom wall 30. Additionally, a pump (not shown) may be connected to the piping system downstream.

An exemplary process may contain a cleaning step or a sampling step. Access to internal components of monitoring system 10 is gained through viewing box 20. Viewing box latch 78 is released, and viewing box cap 74 is rotated about hinge 76 to expose viewing box opening 70. Samples may be taken during operation and internal components of monitoring system 10 may be cleaned after operation, as necessary.

While the present invention has been disclosed and discussed in connection with the foregoing embodiments, it will be understood that the invention is not limited to the embodiments disclosed, but is capable of numerous rearrangements, modifications, and substitutions of parts and elements without departing from the spirit and scope of the invention.

I claim:

1. A system for measuring liquid flow rate in a liquid-gas mixture comprising:
a chamber;
a liquid-gas phase separator;
a collector trap; and
a liquid flow measurement device; wherein;
said liquid-gas phase separator, said collector trap, and said liquid flow measurement device are disposed within said chamber;
said chamber comprises a flow inlet and a flow outlet;
said flow inlet is disposed in an elevated position relative to said flow outlet;
said liquid-gas phase separator is adapted to accept a liquid-gas mixture flowing into said chamber through said flow inlet;
said liquid-gas phase separator is adapted to direct the liquid portion of said liquid-gas mixture to said collector trap; and
said collector trap is adapted to direct said liquid portion to said liquid flow measurement device.

2. The system of claim 1, wherein said chamber comprises one or more sight ports adapted to allow visual observation of at least a portion of the interior of said chamber.

3. The system of claim 2, wherein at least one of said one or more sight ports comprises a plurality of lenses, and wherein at least two of said lenses are disposed with an interstice there between.

4. The system of claim 1, wherein at least a portion of the boundary defining said chamber comprises a double-walled construction which defines a space separate from the interior of said chamber and the exterior of said system.

5. The system of claim 3, wherein:
at least a portion of the boundary defining said chamber comprises a double-walled construction which defines a space separate from the interior of said chamber and the exterior of said system; and
said space is in fluid communication with said interstice.

6. The system of claim 5, further comprising a heating mechanism adapted to heat one or more components selected from the group consisting of:
said chamber;
said lenses;
said space; and
said interstice.

7. The system of claim 1, further comprising a mechanism manipulable to allow access to the interior of said chamber.

8. The system of claim 5, further comprising an inert gas disposed within said space and said interstice.

9. The system of claim 6, wherein at least a portion of said heating mechanism is disposed within said space.

10. The system of claim 9, wherein said heating mechanism comprises one or more tubular components adapted to allow the flow of steam there through.

11. The system of claim 5, wherein said double-walled construction comprises an inner wall and an outer wall, and wherein said interstice is demarcated by one lens sealingly disposed in said inner wall and one lens sealingly disposed in said outer wall.

12. A system for measuring liquid flow rate in a liquid-gas mixture comprising:
a chamber comprising:
a flow inlet disposed in an elevated position relative to a flow outlet; and
one or more sight ports adapted to allow visual observation of at least a portion of the interior of said chamber;
an access mechanism manipulable to allow access to the interior of said chamber;
a liquid-gas phase separator adapted to accept a liquid-gas mixture flowing into said chamber through said flow inlet and separate said mixture into a liquid portion and a gas portion;
a collector trap adapted to accept said liquid portion from said liquid-gas phase separator;
a liquid flow measurement device adapted to accept said liquid portion from said collector trap; and
a heating mechanism; wherein;
said liquid-gas phase separator, said collector trap, and said liquid flow measurement device are disposed within said chamber;
at least a portion of the boundary defining said chamber comprises a double-walled construction, which comprises an inner wall and an outer wall, and which defines a space separate from the interior of said chamber and the exterior of said system;
at least one of said one or more sight ports comprises a plurality of lenses, and wherein one of said lenses is sealingly disposed in said inner wall and one of said lenses is sealingly disposed in said outer wall, with an interstice there between;
said space is in fluid communication with said interstice; and
said heating mechanism is adapted to heat one or more components selected from the group consisting of:
said chamber;
said lenses;
said space; and
said interstice.

13. The system of claim 12, further comprising an inert gas disposed within said space and said interstice.

14. The system of claim 12, wherein said phase separator comprises one or more components selected from the group consisting of:
a funnel;
a splash guard; and
a gas vent;

15. A system for observing liquid flow comprising:
a chamber comprising:
a flow inlet;
a flow outlet;
a heating mechanism; and
one or more sight ports adapted to allow visual observation of at least a portion of the interior of said chamber; wherein;
at least one of said one or more sight ports comprises a plurality of lenses, and wherein at least two of said lenses are disposed with an interstice there between;
at least a portion of the boundary defining said chamber comprises a double-walled construction which defines a space separate from the interior of said chamber and the exterior of said system; and
said space is in fluid communication with said interstice.

16. The system of claim 15, wherein said double-walled construction comprises an inner wall and an outer wall, and wherein said interstice is demarcated by one lens sealingly disposed in said inner wall and one lens sealingly disposed in said outer wall.

17. The system of claim 15, wherein at least a portion of said heating mechanism is disposed within said space.

18. The system of claim 15, further comprising an inert gas disposed within said space and said interstice.

19. The system of claim 15, further comprising a liquid flow measurement device.

20. A method for measuring liquid flow rate in a liquid-gas mixture comprising:
providing a monitoring system comprising:
a liquid-gas phase separator;
a collector trap; and
a liquid flow measurement device;
installing said monitoring system in a liquid-gas mixture piping system;
introducing a liquid-gas mixture into said monitoring system;
separating said liquid-gas mixture into a liquid portion and a gas portion;
collecting said liquid portion; and
measuring the flow of said liquid portion.
